(19) United States
(12) Patent Application Publication
(10) Pub. No.: US 2007/0077185 A1
(43) Pub. Date: Apr. 5, 2007

(54) Method for operating fluids of chemical apparatus

(75) Inventors: Tomohide Ueyama, Minami-Ashigara-shi (JP); Hideharu Nagasawa, Minami-Ashigara-shi (JP); Yasunori Ichikawa, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION

(21) Appl. No.: 11/529,431

(22) Filed: Sep. 29, 2006

(30) Foreign Application Priority Data
Sep. 30, 2005 (JP) 2005-288788

(51) Int. Cl. B01J 19/00; B01J 19/24

(52) U.S. Cl. 422/129

(57) ABSTRACT

The present invention provides a method for operating fluids of a chemical apparatus which performs reaction operations or unit operations by causing multiple kinds of fluids having different densities to join together through respective fluid supply passages and flow into one flow passage and forming a mutually continuous interface, wherein the flowing direction of the fluids in the flow passage is made substantially parallel to the direction of an acceleration to which the fluids are subjected, and an apparatus for manufacturing pigment particles to which the method for operating fluids of a chemical apparatus, in order to solve the problem that unit operations or reaction operations of multiple kinds of fluids cannot be uniformly performed.

### BACKGROUND OF THE INVENTION

1. Field of the Invention

The present invention relates to a method for operating fluids of a chemical apparatus. More particularly, the present invention relates to a method for operating fluids of a chemical apparatus, which performs chemical engineering unit operations or reaction operations by continuously bringing fluids having different densities into interface contact with each other, in a micro space, and a method and an apparatus for manufacturing pigment particles.

2. Description of the Related Art

A micro chemical apparatus generally called a microreactor performs unit operations or reaction operations, such as mixing and separation, for chemical reactions and material production which utilize phenomena in a micro space having a diameter of several micrometers to several hundreds of micrometers. In a micro space, it is possible to increase the ratio of the surface area (interface area) to the volume of a fluid which flows through the space and, therefore, in recent years micro chemical apparatus has been attracting attention as an innovative technology capable of raising the efficiency and speed of reactions between fluids and of mixing the fluids.

Incidentally, it is said that in a micro space the influence of gravity can be neglected because in general, the influence of an interface is relatively large compared to the influence of gravity.

Chemical Engineering, Vol. 66, No. 2 (2002), “Creation of Micro Chemical Plants” describes that even when a water phase and an oil phase, which have different densities, are caused to flow simultaneously at an inlet of a microchannel, the state of a two-phase flow is maintained due to a difference in interface tension regardless of the direction of gravity. This document also describes that a continuous type separator which does not depend on the direction of gravity is desirable in a micro chemical plant.

On the other hand, there are also examples in which a gravity working on a micro space is used. For example, Japanese Patent Application Laid-Open No. 2004-150980 discloses a method and an apparatus for supplying liquids in a micro chemical chip by using the acceleration of gravity as the driving force for liquid supply. According to this technique, liquids can be supplied at a constant speed by providing a curved flow passage shape which maintains constant the height difference between a liquid surface at an inlet of a micro flow passage and a liquid surface at an outlet thereof.

### SUMMARY OF THE INVENTION

In actuality, however, when multiple fluids having different densities flow through a flow passage, there are cases where a fluid having a high density settles in the direction of gravity, thereby making it impossible to form a uniform reaction interface. This has posed the problem that unit operations or reaction operations cannot be uniformly performed.

Particularly, if phenomena as described above occur in a reaction which generates particles, precipitates and coarse grains are generated within a flow passage and particles having desired properties could not be obtained. Furthermore, the flow passage is clogged with precipitates and generated coarse grains and it has been difficult to form a reaction interface which is more continuous and uniform.

In a curved flow passage shape as described in Japanese Patent Application Laid-Open No. 2004-150980, multiple fluids having different densities are subjected to the influence of the acceleration of gravity and, therefore, there has been a high possibility that problems similar to the above-described problem arise.

The present invention has been made in view of such circumstances as described above and has as its object the provision of a method for operating fluids of a chemical apparatus which can cause reactions to occur by forming a continuous and uniform interface (a laminar flow interface) among multiple kinds of fluids having different densities even under the influence of an acceleration.

To achieve the above object, in a first aspect of the present invention, there is provided a method for operating fluids of a chemical apparatus which performs reaction operations or unit operations by causing multiple kinds of fluids having different densities to join together through respective fluid supply passages and flow into one flow passage and forming a mutually continuous interface, in which the flowing direction of the fluids in the flow passage is made substantially parallel to the direction of an acceleration to which the fluids are subjected.

According to the first aspect of the present invention, in a flow passage, the direction in which multiple kinds of fluids having different densities are caused to flow is made substantially parallel to the direction of an acceleration to which the fluids are subjected (mainly, the direction of the acceleration of gravity). As a result of this, the fluids flowing through the flow passage run or settle in the direction of gravity due to a difference in density, thereby making it possible to suppress nonuniform flowing. Therefore, even in a case where there is a difference in density among the fluids flowing within the flow passage, it is possible to form a continuous and uniform interface among the fluids and to cause a uniform reaction to occur.

Incidentally, in the first aspect, the “unit operations” refer to basic physical operations in a chemical process. These basic physical operations are mixing, separation, filtration, heating, cooling, heat exchange, extraction, crystallization, dissolution, absorption, adsorption and the like. The “reaction operations” refer to operations accompanied by a reaction in a chemical process. These operations accompanied by a reaction are an inonic reaction, an oxidation-reduction reaction, an electrolytic reaction, a nitration reaction, a combustion reaction, a burning reaction, a roasting reaction, a halogenation reaction, a sulfonation reaction, an alkylation reaction, an esterification reaction, a fermentation reaction, a thermal reaction, a catalytic reaction, a radical reaction, a polymerization reaction and the like which are caused to occur in inorganic substances and organic substances.

The “substantially parallel” direction in the first aspect is the same direction as the direction of the acceleration to which the fluids in the flow passage are subjected or a direction reverse to this direction of the acceleration, and the substantially parallel direction can be controlled, for example, by slanting the flow passage.

To achieve the above object, in a second aspect of the present invention, there is provided a method for operating fluids of a chemical apparatus which performs reaction operations or unit operations by causing multiple kinds of fluids having different densities to join together through respective fluid supply passages and flow into one flow passage and forming a mutually continuous interface, in which an acceleration substantially reverse to the direction of the acceleration to which the fluids are subjected in the flow passage is applied.

According to the second aspect of the present invention, because an acceleration substantially reverse to the direction of the acceleration to which the fluids are subjected in the flow passage (mainly, the acceleration of gravity) is applied, it is possible to reduce the acceleration to which the fluids in the flow passage are subjected. Therefore, even in a case where the fluids are affected by an acceleration, it is possible to form a continuous and uniform interface among multiple fluids having different densities regardless of the flowing direction of the fluids and it is possible to cause a uniform reaction to occur. Incidentally, it is preferred that the magnitude of the acceleration in a direction substantially reverse to the acceleration to which the fluids are subjected be equivalent to the acceleration to which the fluids are subjected.

Incidentally, in the second aspect, unlike the acceleration to which the fluids in the flow passage are already subjected, “an acceleration substantially reverse to the direction of the acceleration to which the fluids are subjected” is an acceleration by a force in a given direction which is applied from the outside. For example, it is desirable to adopt a method which involves applying a magnetic force from outside the flow passage in a direction reverse to the acceleration of gravity, a method which involves fixing the flow passage to a moving body which is falling thereby to bring the moving body into a weightless state, and the like.

A third aspect is characterized in that in the first or second aspect, the fluids form a laminar flow in the flow passage.

In a case where multiple kinds of fluids having different densities flow in a laminar flow, a continuous interface is formed and, therefore, a reaction can be caused to occur uniformly. On the other hand, the fluids are apt to be affected by an acceleration and hence flowing is apt to become nonuniform. According to the third aspect, also in such a case, the influence of an acceleration can be reduced and, therefore, the effects of the present invention can be favorably obtained. Incidentally, a laminar flow can be controlled mainly by optimizing conditions, such as the density, viscosity and cross-sectional average flow velocity of a fluid and the inside diameter of a flow passage.

A fourth aspect is characterized in that in any one of the first to third aspects, the acceleration to which the fluids are subjected is an acceleration of gravity.

The fourth aspect concretely shows the acceleration to which the fluids in the flow passage are subjected. However, the fourth aspect is not limited by this, and the fourth aspect also includes an acceleration which is generated by a force in a given direction (including a resultant of several kinds of forces) to which the fluids flowing in the flow passage are subjected.

A fifth aspect is characterized in that in the second or third aspect, the substantially reverse acceleration is an acceleration generated by at least one force of a centrifugal force and a magnetic force.

A sixth aspect is characterized in that in the fourth aspect, the substantially reverse acceleration is an acceleration generated by a magnetic force.

The fifth and sixth aspects concretely show the substantially reverse acceleration which is applied in a direction in which the acceleration to which the fluids are subjected (mainly, the acceleration of gravity) is canceled.

A seventh aspect is characterized in that in any one of the first to sixth aspects, the fluids form a multi-laminar flow in the flow passage and in that among the fluids, a fluid flowing on a center side of the flow passage has a higher density than a fluid flowing on an inner-wall side of the flow passage.

In a case where the flowing direction of fluids forming a multi-laminar flow is, for example, a direction substantially normal to the acceleration of gravity, if a fluid having a high density is caused to flow, then the fluid is apt to run in the direction of gravity and flowing is apt to become nonuniform. According to the seventh aspect, even under such conditions under which flowing is apt to become nonuniform, the influence of an acceleration can be reduced and, therefore, the effects of the present invention can be favorably obtained.

Incidentally, “a multi-laminar flow” is a flow in which two or more fluids mutually form a laminar flow. For example, in a triple-laminar flow consisting of a fluid L1 which flows through the center of a flow passage, a fluid L2 which flows around the fluid L1, and a fluid L3 which flows around the fluid L2 in contact with an inner-wall surface of the flow passage, there are a case where L3<L1 or L2, a case where L2<L1, and the like.

The effects of the present invention further increase if the density of the fluid flowing on the center side of the flow passage is not less than 1.001 times, preferably not less than 1.01 times, and more preferably not less than 1.1 times the density of the fluid flowing on the inner-wall surface side.

An eighth aspect is characterized in that in any one of the first to sixth aspects, the fluids form a multi-laminar flow in the flow passage, and in that a fluid flowing on an inner side while adjoining a fluid of an outermost lamina flowing in contact with an inner-wall surface of the flow passage has a higher density than the fluid of the outermost lamina.

The eighth aspect specifies a difference in density between two adjoining liquids of the outermost lamina of a multi-laminar flow, i.e., a fluid of the outermost lamina flowing in contact with an inner-wall surface of the flow passage and a fluid flowing on an inner side of this fluid of the outermost lamina while adjoining the fluid of the outermost lamina. Because the influence of an acceleration can be thus reduced near the inner-wall surface of the flow passage where flowing is apt to become nonuniform, the present invention is particularly effective. Incidentally, the effects of the present invention further increase if between the two liquids, the density of the fluid flowing on the center side of the flow passage is not less than 1.001 times, preferably not less than 1.01 times, and more preferably not less than 1.1 times the density of the fluid flowing in contact with the inner-wall surface.

A ninth aspect is characterized in that in any one of the first to eighth aspects, the fluid flowing on the center side of the flow passage flows without being in contact with the inner-wall surface of the flow passage.

In the fluid flowing on the center side of the flow passage without being in contact with the inner-wall surface of the flow passage, flowing is apt to become nonuniform. According to the ninth aspect, even under such conditions under which the fluid is not held by the inner-wall surface, the influence of the acceleration of gravity due to a difference in density among fluids can be reduced and, therefore, the effects of the present invention can be favorably obtained.

A tenth aspect is characterized in that in any one of the first to ninth aspects, the fluid flowing on the inner-wall surface side of the flow passage has a higher flow velocity than the fluid flowing on the center side of the flow passage.

In the fluid flowing along the inner-wall surface of the flow passage, the flow velocity is apt to decrease due to the frictional force which rubs the inner-wall surface (shearing stress) and also flowing is apt to become nonuniform. According to the tenth aspect, because the flow velocity of the fluid flowing along the inner-wall surface of the flow passage is high, it is possible to suppress nonuniform flowing and the effects of the present invention can be favorably obtained.

An eleventh aspect is characterized in that in any one of the first to tenth aspects, the fluid flowing in contact with the inner-wall surface of the flow passage has a contact angle of not more than 90 degrees with respect to the inner-wall surface of the flow passage.

According to the eleventh aspect, nonuniform flowing due to the frictional force (shearing stress) can be suppressed because of the high wettability of the fluid flowing in contact with the inner-wall surface of the flow passage, and even among fluids having a difference in density, it is possible to cause a reaction to occur by forming a laminar flow interface. Also, because the area of contact between the inner-wall surface and the fluid increases, the fluid is easily held by the inner-wall surface and the effects of the present invention can be favorably obtained. Incidentally, the contact angle of the fluid flowing in contact with the inner-wall surface of the flow passage with respect to the inner-wall surface of the flow passage is preferably not more than 90 degrees, more preferably not more than 60 degrees. The contact angle in the eleventh aspect is a value obtained at room temperature (about 25° C.).

A twelfth aspect is characterized in that in any one of the first to eleventh aspects, the flow passage is a micro flow passage having an equivalent diameter of not more than 1 mm.

Also in a micro space, it is impossible to ignore the influence of the acceleration of gravity and the like. According to the eleventh aspect, within the micro flow passage, multiple kinds of fluids having different densities can form a continuous laminar flow interface among the fluids without being affected by the acceleration of gravity and it is possible to cause a reaction to occur uniformly.

A thirteenth aspect is characterized in that in the twelfth aspect, within the micro flow passage, the fluids are caused to flow in a direction which is almost the same direction as the acceleration of gravity to which the fluids are subjected.

According to the thirteenth aspect, it is possible to cause a reaction to occur by forming a uniform interface, because the acceleration of gravity to which the fluids having different densities within the micro flow passage are subjected does not work in a direction in which a mutually continuous interface of the fluids is made nonuniform. In the thirteenth aspect, “almost the same direction” is such that the angle of the flowing direction of the fluids formed with the direction of the acceleration to which the fluids are subjected in the flow passage is preferably in the range of 0 to 45 degrees, more preferably in the range of 0 to 10 degrees, and most preferably in the range of 0 to 1 degree.

A fourteenth aspect is characterized in that the method for operating fluids of a chemical apparatus according to any one of the first to thirteenth aspects is applied to a method for manufacturing pigment particles.

According to the fourteenth aspect, for example, even in a case where the acceleration of gravity has an influence, it is possible to cause a reaction to occur by forming a continuous and uniform interface among the raw material fluids of pigment particles having different densities. Therefore, it is possible to suppress the generation of precipitates and coarse grains which occur due to nonuniform flowing and hence it is possible to obtain pigment particles having a micro particle diameter and good monodispersibility. Also, generated pigment particles can be collected with efficiency.

A fifteenth aspect is characterized in that the method for operating fluids of a chemical apparatus according to any one of the first to thirteenth aspects is applied to an apparatus for manufacturing pigment particles.

In the fifteenth aspect, a method for operating fluids of a chemical apparatus related to the present invention is applied to an apparatus for manufacturing pigment particles. For example, as a device for realizing a method for operating fluids of a chemical apparatus related to the present invention, it is possible to use a device which tilts a flow passage, a zero gravity device (a moving device which moves in the direction of gravity), a device which applies a magnetic force and the like.

As described above, according to the present invention, it is possible to cause reactions to occur by forming a continuous and uniform interface (a laminar flow interface) among multiple kinds of fluids having different densities even under the influence of an acceleration.

### BRIEF DESCRIPTION OF THE DRAWINGS

FIGS. 1A and 1B are schematic diagrams which explain the installation condition of a cylindrical laminar-flow type micro chemical apparatus to which the present invention is applied in the first embodiment of a method for operating fluids of a chemical apparatus of the present invention;

FIGS. 2A and 2B are sectional views which explain the internal construction of the cylindrical laminar-flow type micro chemical apparatus in FIGS. 1A and 1B;

FIG. 3 is a schematic diagram which explains the installation condition of a cylindrical laminar-flow type micro chemical apparatus to which the present invention is applied in the second embodiment of a method for operating fluids of a chemical apparatus of the present invention;

FIGS. 4A and 4B are schematic diagrams which explain the flowing condition of solutions in the embodiment;

FIGS. 5A and 5B are schematic diagrams which explain the flowing condition of solutions in the embodiment;

FIGS. 6A and 6B are photo diagrams of the measurement of the flowing condition in the cylindrical laminar-flow type micro chemical apparatus in the embodiment;

FIGS. 7A and 7B are graphs which show the results of measurement of grain size distribution; and

FIG. 8 is a schematic diagram which explains the flowing condition in a conventional cylindrical laminar-flow type micro chemical apparatus.

### DETAILED DESCRIPTION OF THE PREFERRED EMBODIMENTS

Hereinafter, with reference to the accompanying drawings, a detailed description will be given of preferred embodiments of a method for operating fluids of a chemical apparatus related to the present invention.

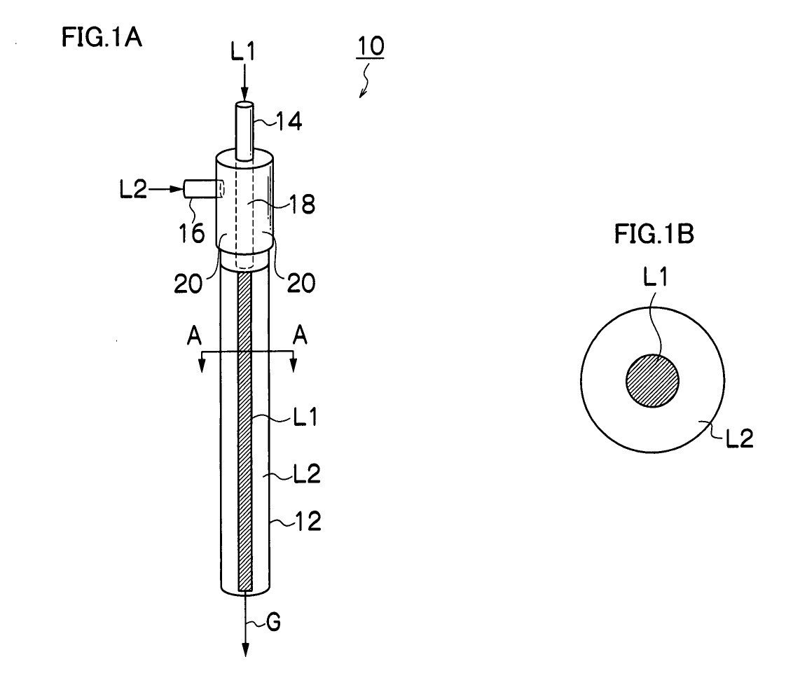

A description will be given of the first embodiment of a method for operating fluids of a chemical apparatus in the present invention. This embodiment is a method for operating fluids by causing the liquid to flow in the same direction as the direction of gravity in a cylindrical laminar-flow type micro chemical apparatus 10 of FIGS. 1A and 1B (the vertical type). First, the basic construction of the cylindrical laminar-flow type micro chemical apparatus 10 of the present invention is described. Hereinafter, the letter G attached to an arrow in the figures indicates the acceleration of gravity.

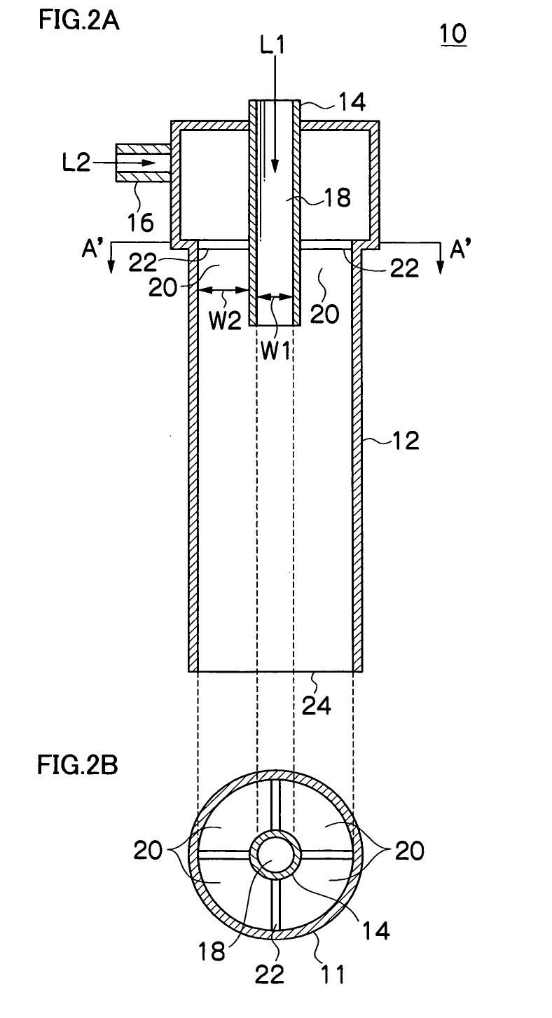

FIG. 1A is an external view obtained when the cylindrical laminar-flow type micro chemical apparatus 10 is installed vertically (a case where the flowing direction of fluids is the same as the direction of gravity), and FIGS. 2A and 2B are sectional views which explain the internal construction of the cylindrical laminar-flow type micro chemical apparatus 10 of FIGS. 1A and 1B. FIG. 1B is a sectional view taken along the line A-A of FIG. 1A, and FIG. 2B is a sectional view taken along the line A′-A′ of FIG. 2A.

First, the internal construction of the cylindrical laminar-flow type micro chemical apparatus 10 is described. As shown in FIGS. 2A and 2B, the cylindrical laminar-flow type micro chemical apparatus 10 is formed to be substantially cylindrical as a whole, and it is mainly equipped with a cylindrical micro flow passage 12 which causes reactions to occur between liquids L1 and L2 and liquid supply pipes 14, 16 which supply the liquids L1, L2 to the micro flow passage 12.

The micro flow passage 12 is a micro flow passage having a circular section. The equivalent diameter of the micro flow passage 12 is preferably not more than 1 mm, more preferably not more than 500 μm. Incidentally, sectional shapes such as a rectangle, a trapezoid and a semicircle can be adopted in addition to a circle.

Upon the leading end surface of the micro flow passage 12, there is opened a discharge outlet 24 for a reaction product LM after the reaction of the liquids L1, L2. A space compartmented in annular shape by the liquid supply pipe 14 is formed on the side of the base end portion of the micro flow passage 12. The base end surface of the micro flow passage 12 is blocked by a cover plate 23 in the form of a circular plate, and the liquid supply pipe 14 is provided coaxially so as to be inserted from the center part of the cover plate 21 into the micro flow passage 12. The interior of the liquid supply pipe 14 provides a liquid supply channel 18 which supplies the liquid L1.

Multiple spacers 22 (four spacers in this embodiment) are interposed between the inner-wall surface of the micro flow passage 12 and the outer-wall surface of the liquid supply pipe 14. These spacers 22 are formed in the shape of a rectangular plate. In this manner, an annular liquid supply channel 20 is formed between the liquid supply pipe 14 and the micro flow passage 12, and this liquid supply channel 20 is provided with the liquid supply pipe 16 which supplies the liquid L2.

Liquid feed pumps (syringe pumps or the like) which supply the liquids L1, L2 (not shown) are connected to the two liquid supply pipes 14, 16. Incidentally, as the liquid feed pumps used in this embodiment, any pump can be used so long as it can positively feed the liquids L1, L2 and can adjust the flow velocity.

The liquid supply channel 18 is opened in the form of a circle and the liquid supply channel 20 is opened in the form of an annulus, the two being formed so as to be mutually concentric. The opening widths W1 and W2 determine the opening areas of the respective supply ports, and the initial flow velocities of the liquids L1, L2 which are introduced into the micro flow passage 12 are fixed according to the opening areas and the supply volumes of the liquids L1, L2. It is necessary that the length L of the micro flow passage 12 be set at a larger length than the length along which the reactions of the liquids L1, L2 are completed.

As the materials for the members which constitute the cylindrical laminar-flow type micro chemical apparatus 10, it is desirable to use materials which have high strength and corrosion resisting properties and increase the fluidity of raw material fluids. For example, metals (iron, aluminum, stainless steel, titanium, other various kinds of metals), resins (fluoroplastics, acrylic resins and the like), glasses (quartz and the like), ceramics (silicone and the like), etc. can be advantageously used.

As fluids used in this embodiment, any fluid may be used so long as it is necessary for obtaining products. For example, liquids, gases, solid-liquid mixtures which are such that solid particles and the like are dispersed in a liquid, gas-liquid mixtures which are such that gases are dispersed in a gas without being dissolved, and the like may be used.

Next, a method for operating fluids of the present invention will be described by using the cylindrical laminar-flow type micro chemical apparatus 10 constructed as described above.

First, as shown in FIGS. 1A and 1B, the liquids L1, L2 having different densities (density: L1>L2), which have been supplied to the liquid supply channels 18, 20 by use of syringe pumps (not shown), join together in the micro flow passage 12 and flow with forming a round shape laminar flow and an annular laminar flow which surround the outer circumference of the round shape laminar flow (refer to FIG. 1B). And the two liquids L1, L2 flowing through the micro flow passage 12 diffuse in the normal direction of a contact interface between the laminar flows which adjoin each other and perform reactions such as the synthesis of particles.

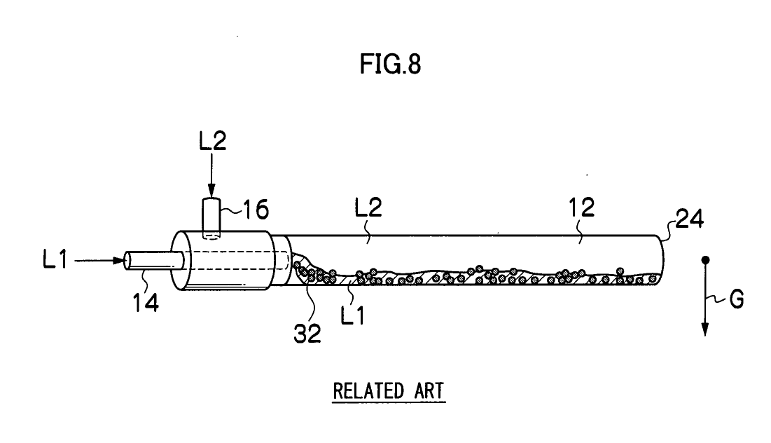

At this time, as shown in FIG. 8, in a case where the micro flow passage 12 is installed horizontally as in the conventional way, the density of the liquid L1 flowing on the center side of the micro flow passage 12 is higher than that of the liquid L2 flowing in annular shape at the peripheral portion of the liquid L1 and, therefore, the liquids are affected by the acceleration of gravity already at the point of the initial stage of confluence and run in the direction of gravity. For this reason, it is impossible to form a mutually continuous and uniform laminar flow interface between the liquids L1 and L2 and the flowing becomes nonuniform. Also, this makes it impossible to cause reactions to occur uniformly, with the result that precipitates and coarse grains are generated, thereby making it impossible to obtain particles having a micro particle diameter and good monodispersibility.

Therefore, in the present invention, as shown in FIGS. 1A and 1B, the micro flow passage 12 is installed vertically so that the flowing direction of the liquids L1, L2 becomes the same direction as the acceleration of gravity. As a result of this, because the acceleration of gravity works in the flowing direction of the liquids L1, L2 and generated particles, the acceleration of gravity has no influence in the direction in which the liquids L1, L2 diffuse and react mutually. Therefore, it is possible for the liquids L1, L2 to form a laminar flow interface at which the liquids adjoin each other, and it is possible to continuously obtain particles having a micro particle diameter and good monodispersibility.

The flowing direction of the liquids L1, L2 in the micro flow passage 12 can be made substantially parallel to the acceleration of gravity to which the liquids L1, L2 are subjected, by adjusting the inclination angle of the micro flow passage 12.

In order to favorably obtain the effects of the present invention, it is preferred that the flow velocity of the liquid L2 flowing in contact with the inner-wall surface of the micro flow passage 12 be made higher than that of the liquid L1 in the range of a laminar flow. As a result of this, it is possible to suppress nonuniform flowing due to the frictional force (shearing stress) which is generated when the liquid L2 rubs the inner-wall surface and, therefore, it is easy to maintain a uniform laminar flow interface with the liquid L1. The flow velocity of the fluids can be adjusted by controlling the flow velocity of the syringe pumps which feed each liquid to the micro flow passage 12, by changing the inside diameter of the micro flow passage 12 and by other methods.

It is preferred that the liquid L2, which forms an annular laminar flow so as to surround the periphery of the liquid L1, have high wettability with the inner-wall surface of the micro flow passage 12. When the wettability is high, the area of the contact interface between the L2 and the inner-wall surface of the micro flow passage 12 increases and the liquid L2 becomes easily held by the inner-wall surface. Therefore, the flowing of the liquid L2 is made uniform and a laminar flow interface between the liquids L1 and L2 can be formed in a more stable manner.

Incidentally, the affinity between the inner-wall surface of the flow passage and the liquids can be adjusted by the physical properties (roughness, materials and the like) of the inner-wall surface of the flow passage and chemical surface treatment (washing by a liquid having a surface tension equivalent to that of the liquid L2, various surface coatings, etc.). For example, it is preferred that the inner-wall surface of the flow passage be a smooth surface having low roughness. Furthermore, the contact angle of the fluid flowing in contact with the inner-wall surface of the flow passage with respect to the material for the inner-wall surface of the flow passage is preferably not more than 90 degrees, more preferably not more than 60 degrees.

It is preferred that a difference in the surface tension of liquids at an interface at which the liquids are in contact with each other be small, and it is preferred that the interfacial tension be low as far as possible. Although the interfacial tension changes depending on the components of the liquids and the temperature, natural emulsification may sometimes occur when the interfacial tension is lowered by using a surfactant, and this is undesirable.

Although in this embodiment, the description has been given of the reactions between multiple kinds of fluids having different densities, a method which involves eliminating a difference in density by mixing a substance which is inactive to reactions is also effective. If this method is adopted, the influence of the acceleration of gravity due to a difference in density and the like is reduced and it is possible to form a continuous interface in a stable manner.

Also, in this embodiment, the description has been given of the case where the liquids are subjected to the acceleration of gravity. However, the present invention is not limited by this case, and can also be applied to a case where the liquids are subjected to a force in a given direction (including a resultant of multiple kinds of forces). The effect of the present invention can be favorably obtained, in the case that, for the flowing direction of the liquids L1, L2, the angle of the flowing direction of the liquids L1, L2 formed with respect to the direction of the acceleration of gravity is 0 to 45 degrees, and for “almost the same direction”, the angle of the flowing direction of the fluids formed with respect to the direction of the acceleration to which the fluids are subjected in the flow passage is 0 to 45 degrees, preferably 0 to 10 degrees, and more preferably 0 to 1 degree.

Because in this manner the multiple kinds of fluids having different densities are caused to flow almost in the same direction as the acceleration of gravity to which the fluids are subjected, it is possible to form a uniform laminar flow interface and hence it is possible to cause a reaction to occur uniformly. Therefore, desired reaction products can be obtained. In some reactions, the interfacial tension of a two-fluid interface may change. Although in such cases, the liquids are apt to be affected particularly by an acceleration, the effects of the present invention can be favorably obtained even under such flowing conditions.

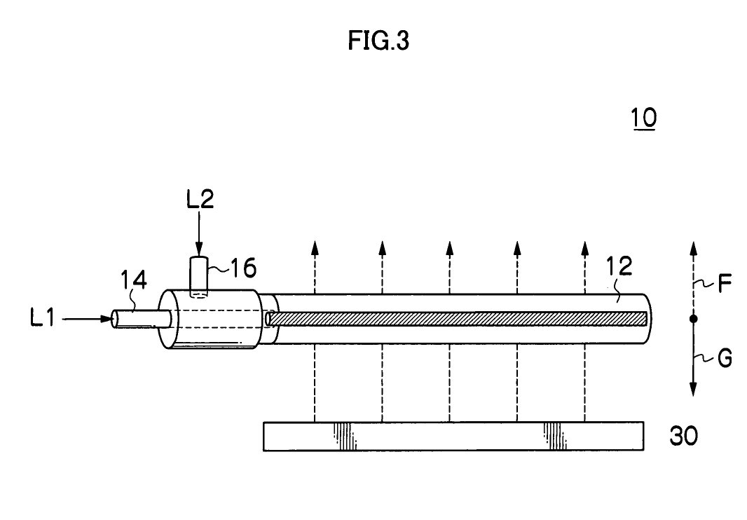

Next, a description will be given of the second embodiment of a method for operating fluids of a chemical apparatus in the present invention. In this embodiment, in a cylindrical laminar-flow type micro chemical apparatus 10 of FIG. 3, the acceleration of gravity is canceled by applying an acceleration from the outside in a direction reverse to gravity, whereby fluids are operated. FIG. 3 is a schematic diagram which explains the cylindrical laminar-flow type micro chemical apparatus 10 in this embodiment. Hereinafter, the letter G attached to an arrow in the figures indicates the acceleration of gravity and the letter F indicates an acceleration in a direction substantially reverse to the acceleration which is applied from the outside and to which the fluids are subjected. As shown in FIG. 3, the same construction as in the first embodiment is adopted, with the exception that the cylindrical laminar-flow type micro chemical apparatus 10 is installed horizontally and that there is provided a magnetic force application device 30 which applies a magnetic force from outside the micro flow passage 12.

The magnetic force application device 30 is arranged in such a manner that a magnetic force can be applied in a direction reverse to the direction of the gravity applied to the horizontal cylindrical laminar-flow type micro chemical apparatus 10. Although concrete examples of the magnetic force application device 30 include, for example, various magnetic field treatment (application) devices, an electromagnet and various kinds of magnets, the magnetic force application device 30 is not especially limited.

As shown in FIG. 3, because a magnetic force is applied in a direction reverse to the direction of gravity (the arrow with a broken line in the figure), the acceleration of gravity to which the liquids L1, L2 in the micro flow passage 12 are subjected is reduced or canceled. As a result of this, it is possible to prevent the liquid L1 having a high density from running (or settling) in the direction of gravity.

Therefore, even when the micro flow passage 12 is installed horizontally, it is possible to form a mutual laminar flow interface between the liquids L1 and L2. As a result of this, it is possible to prevent the generation of precipitates and coarse grains and the like.

At this time, it is preferred that a magnetic force equivalent to the acceleration of gravity be applied. As a result of this, the acceleration of gravity is practically canceled and it is possible to cause a reaction to occur uniformly regardless of the direction of installation. Also, even when the direction is not completely reverse to the direction of gravity, the direction of gravity can be reduced if the angle is within a given range. For this angle, the direction of the acceleration applied from the outside with respect to the direction of gravity is preferably 135 degrees to 180 degrees, more preferably 170 degrees to 180 degrees, and most preferably 179 degrees to 180 degrees.

Although in this embodiment, the description has been given of the method for applying a magnetic force from the outside, the present invention is not limited by this. It is also effective to adopt a method which involves fixing the cylindrical laminar-flow type micro chemical apparatus 10 to a moving body which is falling in the direction of gravity, thereby bringing the moving body into a weightless condition. At this time, it is preferred that the magnitude of the acceleration which is applied be equivalent to the acceleration to which the fluids are subjected, and this magnitude of the acceleration which is applied can be adjusted by controlling the intensity of a magnetic field in the case where a magnetic force is applied, by controlling the fall velocity in the case where a weightless condition is produced, and by other methods.

Although in the first and second embodiments the descriptions have been given of reactions between two kinds of liquids, the present invention can also be applied to reactions among three or more kinds of fluids. Furthermore, the present invention can also be applied to various kinds of chemical apparatus which are used as manufacturing apparatus, in addition to micro chemical apparatus.

As described above, by applying a method for operating fluids of a chemical apparatus related to the present invention, even in a case where fluids are subjected to an acceleration, it is possible to form a continuous and uniform interface (a laminar flow interface) among multiple kinds of fluids having different densities and hence to cause a reaction to occur uniformly. Therefore, it is possible to suppress the generation of precipitations and coarse grains which occur due to nonuniform reactions and to obtain desired reaction products. Also, it is possible to efficiently collect reaction products without causing the reaction products to settle in the flow passage.

Hereinafter, as examples of application of a method for operating fluids of a chemical apparatus related to the present invention, a description will be given of cases where a dispersion liquid of pigment particles excellent in monodispersibility is synthesized by use of the cylindrical laminar-flow type micro chemical apparatus 10. However, the present invention is not limited by these embodiments.

The synthesis of a dispersion liquid of pigment particles is performed by bringing a solution L1 in which an organic pigment, a dispersant and the like are dissolved and an aqueous medium L2 into contact with each other, whereby the organic solvent is caused to precipitate.

(Preparation of Raw Material Solution)

Dimethyl sulfoxide (DMSO) and caustic potash were mixed and while performing stirring at room temperature, dimethyl quinacridone pigment was added and stirred. After that, impurities and the like were removed by use of a filter and a 1 wt % dimethyl quinacridone solution (the solution L1) was obtained. Distilled water was used as the solution L2. Incidentally, the density of the solution L1 was 1.1 g/ml and the density of the solution L2 was 1.0 g/ml.

1) Effect of Interaction with Wall Surface

First, an examination was made into the holding action of an inner-wall surface of a flow passage in addition to the acceleration of gravity as factors affecting the flowing condition of fluids having different densities.

The synthesis of a dispersion liquid of pigment particles was performed in a case where a micro flow passage 12 having a rectangular sectional shape is installed horizontally. The solution L1 and the solution L2 were supplied, respectively, at a flow velocity of 1 μl/minute and a flow velocity of 2 μl/minute to a rectangular flow passage having a flow passage section of 0.5×0.27 mm (sectional area: 0.135 mm²).

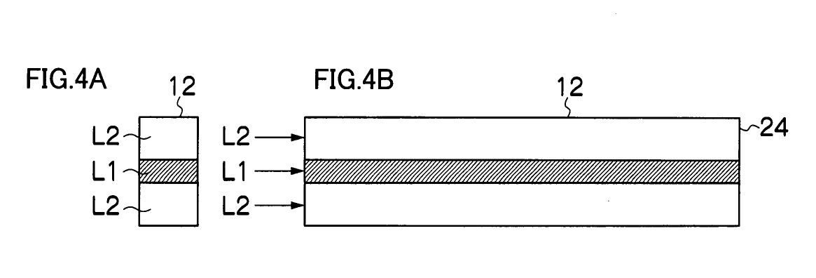

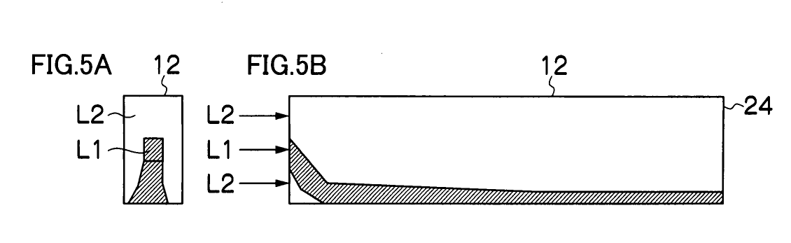

FIGS. 4A and 4B are schematic diagrams of the micro flow passage 12 in which the solution L1 is caused to flow through the center part is held by a wall surface, and FIGS. 5A and 5B are schematic diagrams of the micro flow passage 12 in which the solution L1 is caused to flow through the center part is without being in contact with a wall surface. FIG. 4A is a sectional view near the inlet of the micro flow passage 12, and FIG. 4B is a side view. Similarly, FIG. 5A is a sectional view near the inlet of the micro flow passage 12, and FIG. 5B is a side view.

As shown in FIGS. 4A and 4B, in the case where the solution L1 flowing through the center part of the micro flow passage 12 is held by a wall surface, the running of the solution L1 in the direction of gravity does not occur and a relatively uniform and continuous laminar flow interface was formed.

On the other hand, as shown in FIGS. 5A and 5B, in the case where the solution L1 is not held by a wall surface, the solution L1 ran in the direction of gravity and did not form a laminar flow interface with the solution L2.

From the foregoing, it became apparent that the solution L1 flowing through the center of the flow passage comes into contact with an inner-surface wall, with the result that the flowing is kept uniform by the action of being held by the inner-wall surface in addition to the influence of the acceleration of gravity.

2) Effect of Flowing Direction

An investigation was made into the effect of the direction of acceleration to which the solutions L1, L2 are subjected on the flowing of the solutions by use of the cylindrical laminar-flow type micro chemical apparatus 10 in this embodiment.

A glass capillary having an inside diameter of 1 mm (in FIGS. 2A and 2B, W1=0.1 mm, W2=0.4 mm) was used as the micro flow passage 12, and the solution L1 and the solution L2 were supplied, respectively, at a flow velocity of 1 μl/minute and a flow velocity of 80 μl/minute. Incidentally, the solution L1 was caused to flow through the center part without being in contact with an inner-wall surface of the micro flow passage 12.

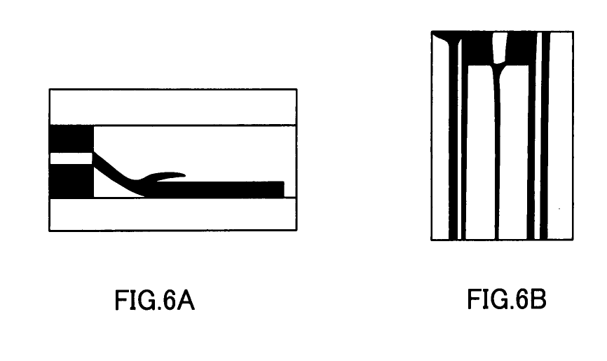

As shown in the photograph of FIG. 6A, in the case of horizontal installation, the solution L1 was affected by the acceleration of gravity due to a difference in density in the initial stage of the confluence and ran (settled) onto an inner-wall surface of the glass capillary having an inside diameter of 1 mm. For this reason, coarse grains were formed and it was impossible to form grains in a stable manner.

On the other hand, as shown in the photograph of FIG. 6B, in the case of vertical installation, the solutions L1, L2 formed a laminar flow interface in a stable manner already in the initial stage of the confluence and it was possible to generate pigment particles having high monodispersibility.

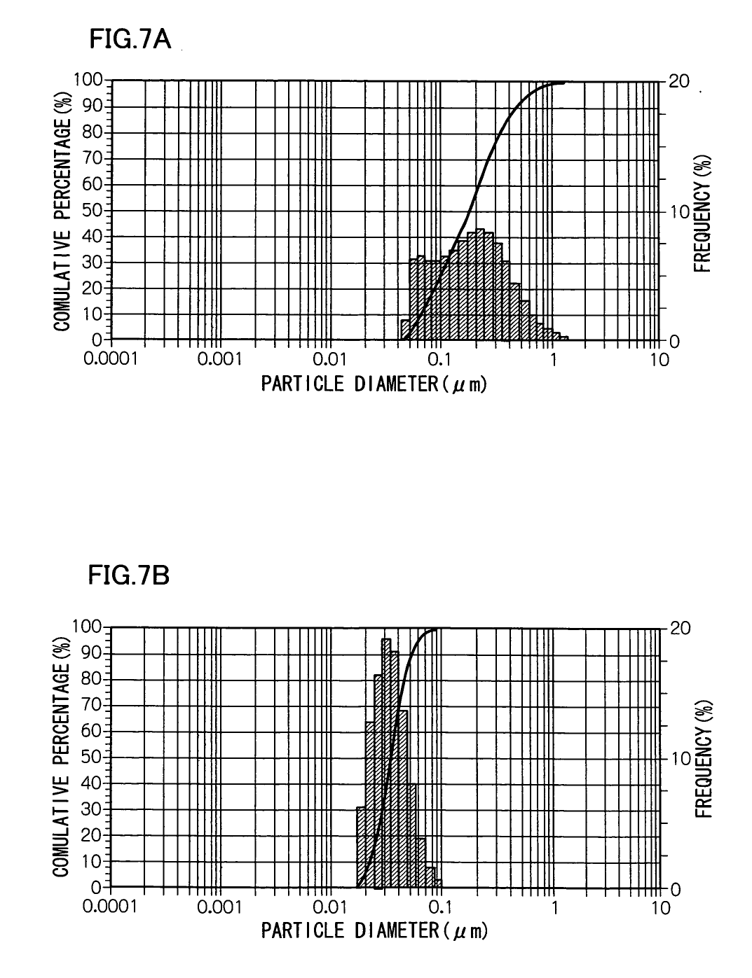

The grain size distribution of pigment particles collected at a discharge outlet 24 of the micro flow passage 12 was measured in both cases. FIGS. 7A and 7B are graphs which show the results of the measurement of the grain size distribution of pigment particles in both cases. FIG. 7A shows the grain size distribution of the case of FIG. 6A, and FIG. 7B shows the grain size distribution of the case of FIG. 6B.

As shown in FIG. 7A, the grain size distribution of pigment particles obtained in the case of FIG. 6A, was broad in the range of 50 to 1000 nm. This suggests that the grain diameters are nonuniform and that pigment particles having desired grain diameters cannot be uniformly synthesized.

On the other hand, as shown in FIG. 7B, the grain size distribution of pigment particles obtained in the case of FIG. 6B showed a sharp peak near about 35 nm and the grain diameters were almost equivalent to desired grain diameters. From this, it could be ascertained that pigment particles having the desired grain diameters had been uniformly synthesized.

From the results of 1) and 2) above, it became apparent that within the micro flow passage 12, particularly under conditions in which the flowing is apt to become nonuniform, such as a case where a solution is not held by the inner-wall surface of the flow passage, the effect of a reduction of the influence of an acceleration is remarkably produced.

Although as described above, the present invention is suitable for the generation of pigment particles excellent in monodispersibility, the present invention is not limited thereby. It is also possible to apply the present invention to the synthesis of various kinds of micro capsules or emulsions, the synthesis of particles, such as the synthesis of photosensitive paint solutions, liquid-liquid reactions which occur when the liquids do not contain particles, gas-liquid reactions or the like.

What is claimed is:

1. A method for operating fluids of a chemical apparatus which performs reaction operations or unit operations by causing multiple kinds of fluids having different densities to join together through respective fluid supply passages and flow into one flow passage and forming a mutually continuous interface, wherein
a flowing direction of the fluids in the flow passage is made substantially parallel to the direction of an acceleration to which the fluids are subjected.

2. A method for operating fluids of a chemical apparatus which performs reaction operations or unit operations by causing multiple kinds of fluids having different densities to join together through respective fluid supply passages and flow into one flow passage and forming a mutually continuous interface, wherein
an acceleration substantially reverse to the direction of the acceleration to which the fluids are subjected in the flow passage is applied.

3. The method for operating fluids of a chemical apparatus according to claim 1, wherein
the fluids form a laminar flow in the flow passage.

4. The method for operating fluids of a chemical apparatus according to claim 1, wherein
the acceleration to which the fluids are subjected is an acceleration of gravity.

5. The method for operating fluids of a chemical apparatus according to claim 1, wherein
the fluids form a multi-laminar flow in the flow passage, and a fluid of the multi-laminar flow flowing on a center side of the flow passage has a higher density than a fluid flowing on an inner-wall side of the flow passage.

6. The method for operating fluids of a chemical apparatus according to claim 1, wherein
the fluids form a multi-laminar flow in the flow passage, and a fluid flowing on an inner side while adjoining a fluid of an outermost lamina flowing in contact with an inner-wall surface of the flow passage has a higher density than the fluid of the outermost lamina.

7. The method for operating fluids of a chemical apparatus according to claim 1, wherein
the fluid flowing on the center side of the flow passage flows without being in contact with the inner-wall surface of the flow passage.

8. The method for operating fluids of a chemical apparatus according to claim 1, wherein
the fluid flowing on the inner-wall surface side of the flow passage has a higher flow velocity than the fluid flowing on the center side of the flow passage.

9. The method for operating fluids of a chemical apparatus according to claim 1, wherein
the fluid flowing in contact with the inner-wall surface of the flow passage has a contact angle of not more than 90 degrees with respect to the inner-wall surface of the flow passage.

10. The method for operating fluids of a chemical apparatus according to claim 1, wherein
the flow passage is a micro flow passage having an equivalent diameter of not more than 1 mm.

11. A method for manufacturing pigment particles to which the method for operating fluids of a chemical apparatus according to claim 1 is applied.

12. An apparatus for manufacturing pigment particles to which the method for operating fluids of a chemical apparatus according to claim 1 is applied.

13. The method for operating fluids of a chemical apparatus according to claim 2, wherein
the fluids form a laminar flow in the flow passage.

14. The method for operating fluids of a chemical apparatus according to claim 2, wherein
the acceleration to which the fluids are subjected is an acceleration of gravity.

15. The method for operating fluids of a chemical apparatus according to claim 2, wherein
the substantially reverse acceleration is an acceleration generated by at least one force of a centrifugal force and a magnetic force.

16. The method for operating fluids of a chemical apparatus according to claim 2, wherein
the fluids form a multi-laminar flow in the flow passage, and a fluid of the multi-laminar flow flowing on a center side of the flow passage has a higher density than a fluid flowing on an inner-wall side of the flow passage.

17. The method for operating fluids of a chemical apparatus according to claim 2, wherein
the fluids form a multi-laminar flow in the flow passage, and a fluid flowing on an inner side while adjoining a fluid of an outermost lamina flowing in contact with an inner-wall surface of the flow passage has a higher density than the fluid of the outermost lamina.

18. The method for operating fluids of a chemical apparatus according to claim 2, wherein
the fluid flowing on the center side of the flow passage flows without being in contact with the inner-wall surface of the flow passage.

19. The method for operating fluids of a chemical apparatus according to claim 2, wherein
the fluid flowing on the inner-wall surface side of the flow passage has a higher flow velocity than the fluid flowing on the center side of the flow passage.

20. The method for operating fluids of a chemical apparatus according to claim 2, wherein
the fluid flowing in contact with the inner-wall surface of the flow passage has a contact angle of not more than 90 degrees with respect to the inner-wall surface of the flow passage.

21. The method for operating fluids of a chemical apparatus according to claim 2, wherein
the flow passage is a micro flow passage having an equivalent diameter of not more than 1 mm.

22. A method for manufacturing pigment particles to which the method for operating fluids of a chemical apparatus according to claim 2 is applied.

23. An apparatus for manufacturing pigment particles to which the method for operating fluids of a chemical apparatus according to claim 2 is applied.

24. The method for operating fluids of a chemical apparatus according to claim 3, wherein
the substantially reverse acceleration is an acceleration generated by at least one force of a centrifugal force and a magnetic force.

25. The method for operating fluids of a chemical apparatus according to claim 14, wherein
the substantially reverse acceleration is an acceleration generated by a magnetic force.

26. The method for operating fluids of a chemical apparatus according to claim 10, wherein
within the micro flow passage, the fluids are caused to flow in a direction which is almost the same direction as the acceleration of gravity to which the fluids are subjected.

27. The method for operating fluids of a chemical apparatus according to claim 21, wherein
within the micro flow passage, the fluids are caused to flow in a direction which is almost the same direction as the acceleration of gravity to which the fluids are subjected.
